(19) United States
(12) Patent Application Publication
(10) Pub. No.: US 2009/0158436 A1
(43) Pub. Date: Jun. 18, 2009

(54) Method for Exporting Use Rights for Electronic Data Objects

(76) Inventor: Gero Bäse, München (DE)

Correspondence Address: STAAS & HALSEY LLP, SUITE 700, 1201 NEW YORK AVENUE, N.W., WASHINGTON, DC, 20005, US

(21) Appl. No.: 11/989,105

(22) PCT Filed: Jun. 27, 2006
(86) PCT No.: PCT/EP2006/063604

§ 371 Date: Jan. 22, 2008

(30) Foreign Application Priority Data
Jul. 19, 2005 (DE) 10 2005 033 698.1

(51) Int. Cl. G06F 21/00; G06F 15/16

(52) U.S. Cl. 726/26; 709/246

(57) ABSTRACT

There currently exists a plurality of digital rights management (DRM) systems on the market, each with its own rights expression language. As a result, when an electronic data object is exported from one DRM system to another DRM system, translation errors are generated, which can cause the irretrievable loss of individual rights granted by the copyright holder. To export rights to use electronic data objects and ensure interoperability between different DRM systems, the original rights to use that can be associated with the electronic data object are exported from data source to the data sink. In this way, the original license is advantageously kept when the rights to use are exported from one DRM system to another DRM system.

### CROSS REFERENCE TO RELATED APPLICATIONS

This application is based on and hereby claims priority to German Application No. 10 2005 033 698.1 filed on Jul. 19, 2005, the contents of which are hereby incorporated by reference.

### BACKGROUND

Described below is a method and a computer program product for exporting use rights for electronic data objects.

Unlike traditional information carriers (e.g. books or gramophone records), computer files and other digital media (CD, DVD) can be copied indefinitely without loss of quality and at no significant cost.

For this reason, access to copy-protected electronic data objects, such as e.g. audio files, video files or software, is usually controlled by electronic protection mechanisms known as “digital rights management” (DRM) systems. DRM systems restrict access to digital offerings to, for example, registered (i.e. paying) users or even enable individual accesses to an offering to be billed on an individual basis. In practice this mostly operates via specially developed file formats which include copy protection or, as the case may be, encryption. These files (e.g. music files from the internet) can then be used only by special programs and by an associated code.

DRM systems implement the concept of centralized control of digital content based on cryptographic methods. This is realized in that any digital content is specifically tied cryptographically to an arbitrary device and/or data medium in a unique manner. Without being issued with the corresponding key for the digital content by the rights holder, the rights acquirer, though able to purchase the device or data medium, cannot access the content. In order to protect and assert the wishes of a rights holder, DRM systems are designed technically in such a way that a key exchange can be performed for each individual device without the user's being able to exercise any influence. This allows the rights holders to employ new sales and marketing modalities, such as, for example, a time-limited leasing of the content.

Currently, there are a plurality of DRM systems existing in parallel on the market, each of which has its own “Rights Expression Language” (REL). A rights expression language is a formal language by which rights can be expressed. Thus, for example, the Open Mobile Alliance (OMA) or Microsoft have their own distinct DRM systems and therefore distinct rights expression languages.

A problem with this state of affairs is how to establish interoperability between the individual DRM systems. On the one hand, for instance, the scope of the rights provided by the rights holder is considerably restricted when an electronic data object is exported from a data processing device with large computing capacities to a data processing device with smaller computing capacities, since it is not possible to make use of the complete rights set due to the smaller computing capacities. On the other hand, exporting an electronic data object from a first DRM system to a second DRM system gives rise to translation errors, in which case individual rights granted by the rights holder can be irretrievably lost. This second disadvantage far outweighs the first and in known solutions can only be remedied by restricting the rights package put together by the rights holder in such a way that the rights are able to be interpreted by all DRM systems available on the market.

### SUMMARY

An aspect is to disclose a method for exporting use rights for electronic data objects which guarantees interoperability between different DRM systems.

According to the method described below for exporting use rights applicable to electronic data objects, original use rights specific to an electronic data object include forms of usage specified by a rights holder. When the use rights applicable to an electronic data object are exported from a data source to a data sink, the use rights are translated from a data source format to a data sink format. The original use rights assignable to the electronic data object are exported from the data source to the data sink in addition. When the use rights are exported from one DRM system to another DRM system, the original license is thereby advantageously preserved, with the result that no rights granted by the rights holder are irretrievably lost.

According to an embodiment, the original use rights and/or the translated use rights are marked by an identifier. In this way it can advantageously be ensured that the exported license can be distinguished from the original license.

According to an advantageous embodiment, the original use rights are translated when the license is exported. In particular, this has the advantageous effect that, for example, when an object is exported from a first DRM system to a second DRM system and is then further exported from the second DRM system to a third DRM system, the original license is translated in each case and consequently the availability of the rights granted by the rights holder is ensured to the greatest possible extent.

According to another advantageous embodiment, the forms of usage encompassed by the original use rights are updated prior to the export. This has the advantage that the rights to an electronic data object already claimed by a rights acquirer are also included and consequently the legitimate interests of the rights holder are also preserved.

According to another advantageous embodiment, the electronic data object is exported by a rights acquirer and/or a rights holder. This means that the method can be used both for exporting an electronic data object from a rights holder to a rights acquirer, i.e. for example from a network operator or service provider to a service user, and for the export of the electronic data object by a rights acquirer, for example to one of the rights acquirer's local terminal devices.

According to another advantageous embodiment, the use rights are not translated by the data source and/or data sink if the electronic data object cannot be executed on the data sink. This advantageously enables a gatekeeper function to be implemented wherein a check is made even before the start of the translation procedure to determine whether the use rights assigned to an electronic data object can or cannot be executed on the respective data sink.

During the execution of a computer program implementing the method described below, original use rights specific to an electronic data object include forms of usage specified by a rights holder. When the use rights applicable to an electronic data object are exported from a data source to a data sink, the use rights are translated from a data source format to a data sink format. The original use rights assignable to the electronic data object are exported from the data source to the data sink in addition.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a schematic illustrating an exporting of use rights assigned to an electronic data object between devices having different digital rights management systems, and

FIG. 2 is a schematic representing a method for exporting use rights applicable to electronic data objects.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

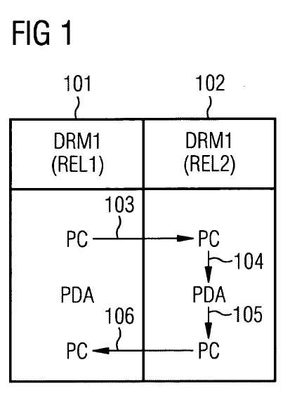

FIG. 1 schematically depicts an operation to export use rights assigned to an electronic data object from devices on which a first DRM system 101 is installed to devices on which a second DRM system 102 is installed. In this case, in the present exemplary embodiment, an electronic data object is transferred in 103 from a PC having the DRM system 1 to a PC having a DRM system 2. Typically, the process results in translation errors occurring between the individual DRM systems, with the possibility that individual rights granted by the rights holder can be irretrievably lost. In 104, the electronic data object is transferred from a PC to a PDA within the DRM system 2. This process gives rise in particular to restriction errors, since the computing capacities of the PDA are very much more limited than those of the PC. This means that in addition to the restriction due to the translation error, the original use rights granted by the rights holder and acquired by the rights acquirer are now subject to a further restriction due to the restriction error. Following a further export of the electronic data object from the PDA to the PC in 105, the restriction of the use rights from 103 and 104 persists, since a translation of the use rights during the export according to the known methods takes place only on the basis of the transferred license. In a final step, the electronic data object is exported from the PC having the DRM system 2 to a PC having a DRM system 1. In this case a further translation error occurs due to the export from one DRM system to a second DRM system. As a result of the exporting over four devices with two DRM systems, the use rights applicable to the electronic data object accordingly experience a twofold restriction due to translation errors and a single restriction due to a restriction error.

If a method is now applied to this exemplary embodiment, a translation error likewise occurs in 103 when exporting from the PC having the DRM system to the PC having the DRM system 2. The original license is also transferred in addition, however. This original license is used in 104 for the translation at the time of the export from the PC having the DRM system 2 to the PDA having the DRM system 2, as a result of which the use rights transferred to the PDA are no longer subject to a restriction due to the translation error, but are henceforth constrained only by the restriction error. At the time of the next export operation from the PDA having the DRM system 2 to the PC having the DRM system 2 in 105, the original license is again drawn upon for the purposes of the translation, as a result of which, in the case of this export operation from a system with small computing capacities to a powerful system with large computing capacities, the use rights can once again be used to the full extent provided by the rights holder. Finally, in the last 106, the electronic data object is transferred from the PC having the DRM system 2 to the PC having the DRM system 1, in which case only one translation error due to the exporting between two different DRM systems occurs. To sum up, it can therefore be stated that, given the same export operations, two translation errors and one restriction error can be observed following a method according to the related art, whereas with the method described herein, only one translation error is observed at the end.

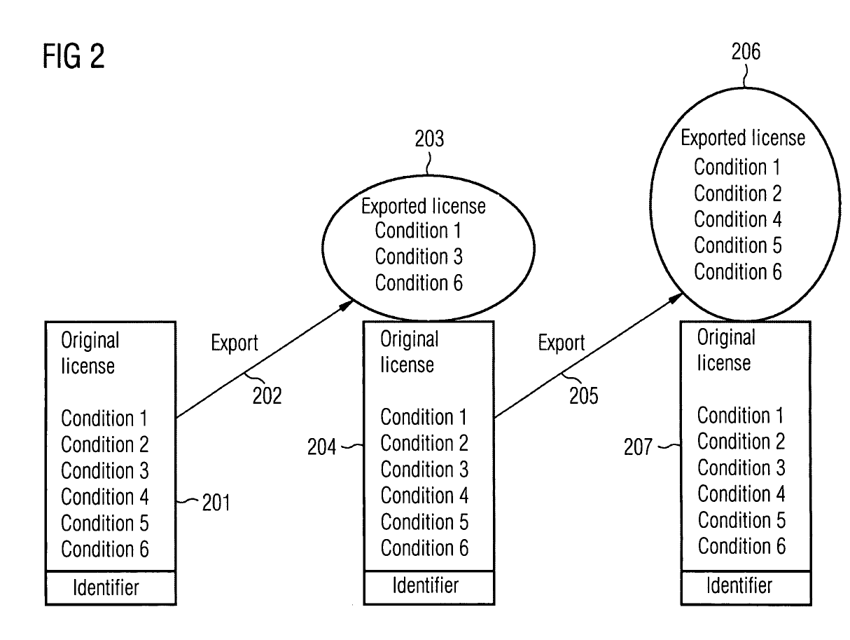

FIG. 2 schematically depicts a method for exporting use rights applicable to electronic data objects. In this exemplary embodiment, the original license 201 provided by the rights holder is present initially, which license includes all forms of usage applicable to the electronic data object that have been granted by the rights holder. During a first export 202 to a system having a second DRM system which does not use the rights expression language in which the original license was drafted. Following the translation of the original license, an exported license 203 is obtained which then makes the forms of usage granted by the rights holder available only to a limited extent. The original license, which is marked by a special identifier, is transferred in addition 204. In a further export operation 205, the original license 204 is transferred to the next data processing device instead of the translated license 203. As a result, the translation of the license in the new data processing device takes place, not on the basis of the exported license 203, which is already limited anyway, but in fact on the basis of the original license 204. The identifier can serve in this case to indicate to the system which license is to be transmitted during an export operation. The exported license 206 is obviously very much more comprehensive than the exported license 203, but nonetheless, not all the forms of usage provided by the rights holder can be used on this data processing device either. The original license, which once again is marked by a special identifier, is exported in addition 207. This exemplary embodiment illustrates the advantageous effect of the method, whereby the license conditions are mapped as far as possible in the system by each of the.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to exemplary embodiments and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for exporting original use rights applicable to an electronic data object, including forms of usage specified by a rights holder, comprising:
translating use rights applicable to an electronic data object from a data source format to a data sink format; and
exporting from a data source to a data sink the use rights in the data sink format and the original use rights assignable to the electronic data object.

13. The method as claimed in claim 12, wherein at least one of the original use rights and the use rights in the data sink format are marked by an identifier.

14. The method as claimed in claim 13, wherein the original use rights are translated.

15. The method as claimed in claim 14, wherein different systems for managing use rights are executed on the data source and data sink.

16. The method as claimed in claim 15, wherein the forms of usage encompassed by the original use rights are updated prior to said exporting.

17. The method as claimed in claim 16, wherein the electronic data object includes at least one of software, text, audio, image and video files.

18. The method as claimed in claim 17, wherein the forms of usage which can be specified include playback, execution, printing, copying and editing of the electronic data object.

19. The method as claimed in claim 18, wherein said exporting is performed by at least one of a rights acquirer and a rights holder.

20. The method as claimed in claim 19, wherein said translating of the use rights is not performed by at least one of the data source and data sink if the electronic data object cannot be executed on the data sink.

21. The method as claimed in claim 20, wherein at least one of the data source and data sink is one of a data processing device and a data medium.

22. A computer-readable medium encoded with a computer program which when loaded into a working memory of a program execution scheduling device and executed by a processor exports rights to use electronic data objects, comprising:
translating use rights applicable to an electronic data object from a data source format to a data sink format; and
exporting from a data source to a data sink the use rights in the data sink format and the original use rights assignable to the electronic data object.
